(19) United States
(12) Patent Application Publication
(10) Pub. No.: US 2013/0065649 A1
(43) Pub. Date: Mar. 14, 2013

(54) PORTABLE BATTERY-POWERED TELEPHONE COMPRISING A SOLAR COLLECTOR FOR RECHARGING SAID BATTERY

(71) Applicants: Qingde Kong, Ningbo (CN); Junjie Zhang, Ningbo (CN); Jinjie Zhao, Ningbo (CN)

(72) Inventors: Qingde Kong, Ningbo (CN); Junjie Zhang, Ningbo (CN); Jinjie Zhao, Ningbo (CN)

(73) Assignee: OPTION, Leuven (BE)

(21) Appl. No.: 13/578,660

(22) PCT Filed: Feb. 11, 2011
(86) PCT No.: PCT/EP2011/052005

§ 371 Date: Nov. 27, 2012

(30) Foreign Application Priority Data
Feb. 12, 2010 (FR) 10/00600

(51) Int. Cl. H04W 52/00

(52) U.S. Cl. 455/566; 455/573

(57) ABSTRACT

A mobile phone powered by a battery (60) and including a solar panel (70) for recharging the battery (60). The phone includes a light detector (80) and an alarm (81), the alarm (81) being turned on, at least for a moment, repeated or not, when the amount of light received by the light detector (80) is greater than a predetermined threshold.

The present invention relates to a mobile phone powered by a battery and comprising a solar panel for recharging the said battery.

Such mobile phones are known. The only FIGURE represents the block diagram of such a mobile phone. It essentially is composed of a control unit 10 connected to a radio frequency signal processing unit 20 with its emitter and its receiver connected to an antenna 21, to an audio processing unit 30 connected to a loudspeaker or earphone 31, to a socket 32 for connecting external earphones and to a microphone 33, to a screen 40 for displaying various messages and video signals for the user and to a keyboard 50 to allow the user to input data.

On some phones, the screen 40 is touch sensitive and also allows, therefore, to enter data. In this case, it may not have a physical keyboard.

The radio frequency processing unit 20, the audio processing unit 30, the screen 40 and the control unit 10 are supplied by a rechargeable battery 60 via a power management unit 61. To be able to recharge the battery 60, it is possible to use an external source connected to a plug 62. The management unit 61 also allows to determine the level of the battery charge 63, the said level being supplied to the control unit 10, in particular for its visualization on the screen 40 as a symbol 41.

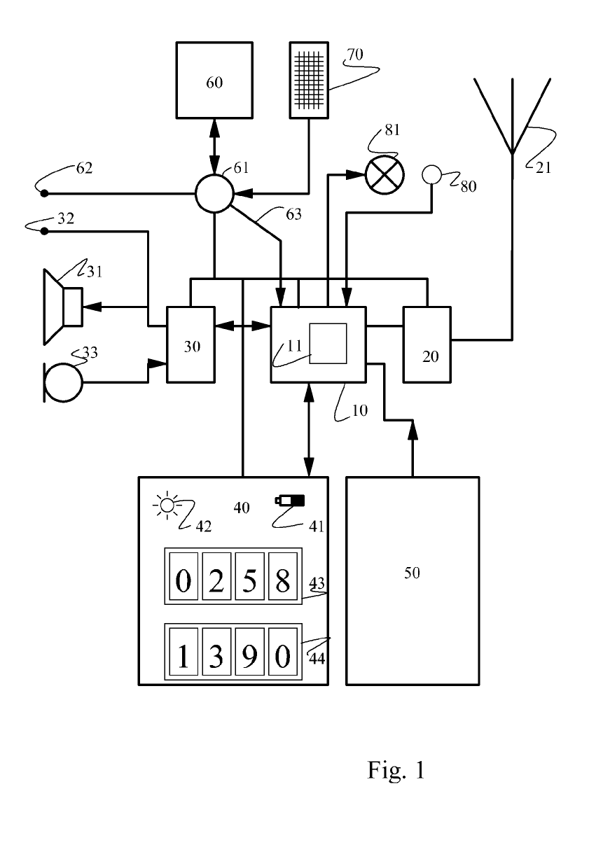

Traditionally, a phone such as the one of FIG. 1 allows a voice call, the sound signals picked up by the microphone 32 being therefore treated in the unit 30, transmitted, by the control unit 10, to the radio frequency unit 20 which emits them in the form of electromagnetic waves and radio frequency signals received by the radio frequency unit 20 being transmitted, by the control unit 10, to the unit 30 to be restored, as sound, by the speaker 31 or by the external headphones plugged into the socket 32. It allows to emit messages such as SMS or MMS that are composed using the keyboard 50 and the display 40 and transmitted via the control unit 10, to the radio frequency unit 20 to be emitted in the form of electromagnetic waves and to receive such messages which are processed in the radio frequency unit 20 and transmitted via the control unit 10, to the screen 40 for viewing.

Generally, such phones allow one to listen to music. To do this, the control unit 10 controls the processing unit 30 so that it processes with the audio signals, either stored in the phone memory or received via the radio frequency unit 20 and transmits them to the speaker 31 or the socket 32 for their restitution. Similarly, they can allow to view videos with image reproduction on the screen 40 and restitution of the sound on the speaker 31 or through external headphones plugged into the socket 32.

It is also possible with such a phone to transmit and receive data, for example from internet sites.

The phone shown in FIG. 1 also comprises a solar panel 70 which is provided to enable recharging of the battery 60. In the illustrated embodiment, it is connected to the management unit 61.

The interest of such a solar panel is to allow the phone user to recharge the battery 60 as little as possible via the plug 62 which is generally connected to a charger itself connected to the mains. But, recharging via the solar panel can generate constraints for the user, such as turning around his phone each time there is enough light, the solar panel being usually placed on the side of the phone which is opposite to the screen 40. Thus, without paying attention, the user may not use or only slightly use such a solar panel for recharging his/her phone battery.

The object of the invention is to provide a mobile phone which is such that the user is encouraged to use as often as possible the solar panel to recharge the battery.

To do this, a mobile phone according to the present invention is of the type powered by a battery and comprising a solar panel for recharging the said battery. It is characterized in that it comprises a light detector and an alarm, the said alarm being activated, at least for a moment, repeated or not, when the amount of light received by the said light detector is greater than a predetermined threshold.

If it is of the type comprising a screen on one of its faces and the said solar panel on the opposite side to that of the screen, the said light detector is advantageously on the side of the said screen.

Advantageously, the said alarm is an indicator, such as a light emitting diode, or means for displaying a symbol on the said screen of the said phone, or sound emitting means.

According to another embodiment of the present invention, the said mobile phone is characterized in that it comprises solar energy counting means that increase a solar energy count value according to the electrical energy delivered by the said solar panel and decrease this solar energy count value according to the energy consumed by the said phone, the counting means being configured such that the solar energy count value cannot fall below the zero value.

Advantageously, the said counting means are provided such that the said solar energy count value is reduced only when predetermined specific operations of the said phone are in use, such as operations for sending SMS, listening to music, voice communications.

Advantageously, the said counting means are provided such that, when the solar energy panel charges the battery, the solar energy count value is increased according to the increasing level of charge of the battery.

Advantageously, the said mobile phone comprises, for each the said predetermined specific operations, a counter with the operation count value being increased when the said operation is implemented, while the energy count value is not zero.

Advantageously, the said counting means are provided for converting the solar energy count value into functioning time for some specific operations and/or into a number of units processed by the said operations.

Advantageously, the said counting means are provided such that the energy count value is reduced by an amount proportional to the functioning time of the operation of interest or the number of units processed by the said operation.

Alternatively, the said counting means are provided such that, when the said phone consumes energy due to the implementation of one of the said predetermined specific operations, the solar energy count value is reduced according to the decrease in the charging level of the battery, without ever dropping below zero.

The aspects of the invention mentioned above, as well as others, will become more apparent upon reading the following description of an exemplary embodiment, the said description being made in relation to the only FIGURE attached representing, in the form a block diagram, a mobile phone according to the present invention.

We will describe more specifically the means used by the invention for stimulating a mobile phone user to use as much as possible the solar panel 70 of his/her device.

We will, therefore, describe this description in relation to the only FIGURE that has already been used to illustrate the problem.

In a first embodiment, these means are formed by a light detector 80 which is provided on the side of the phone which includes the screen 40, and an alarm 81 which is of sound type, such as a buzzer or sound emitting means on the speaker 31 or the external receiver plugged into the socket 32, and/or of light type, such as an indicator formed by a light emitting diode or means for displaying on the screen 40 a particular symbol 42, such as a sunlight or else. Thus, when the amount of light received by the light detector 80 exceeds a predetermined threshold, the user is notified, by turning on, at least for one moment, repeated or not, the alarm 81 that the conditions required for charging the battery 60 by the panel 70 are met and that the user can position his/her phone, for example, turn it around, to do so.

To allow for a better indication, the indicator 81 may have its intensity that depends on the intensity of light received by the light detector 80. Similarly, the drawing of the symbol 42 displayed on the screen 40 can be slightly different according to the intensity of light received

In another embodiment, these means are formed by solar energy counting means 11 that increase a solar energy count value according to the electrical energy supplied by the solar panel 70 and decrease this count value according to the energy consumed by the elements 10, 20, 30 and 40 of the phone. The counting means 11 are provided such that the solar energy count value cannot fall below the zero value.

The counting means 11 are included in the control unit 10. As for the count value, it can be viewed on the screen 40 in a counter 43.

In a particular embodiment, the said solar energy counting means 11 use the charge signal level delivered by the management unit 61. Specifically, when the solar panel 70 charges the battery 60, the battery charge level increases and the count value which is linked to this charge level also increases. When the elements 10 to 40 of the phone consume energy, the count value is reduced, for example according to the decrease in the charge level of the battery 60. Other means to lower the solar energy count value according to the energy consumed are described below.

According to one aspect of the present invention, the said counting means 11 are provided such that the solar energy count value decreases only when the consumption of energy by the phone is due to predetermined specific operations carried out by the user, for example by operations of sending SMS messages, and/or listening to music, and/or voice communications. Thus, if these particular operations are all of those just listed, when the consumption of energy by the phone is due to the transmission or reception of data, e.g. via internet, the count value is unchanged.

By following the solar energy count value, the user has a greater feeling of the usefulness of solar charging than if this value was reduced for all possible predetermined operations, notably because the predetermined operations are chosen to be those most often used while consuming relatively less.

According to another aspect, a mobile phone according to the invention comprises, for each particular operation, a particular counter with the operation count value being increased when the said operation is implemented while the solar energy count value of is not zero. For example, the operational count value can be displayed on the screen 40 in the form of a counter 44. Each operational count value is never diminished and is cumulated over the life of the mobile phone.

Thus, if the solar energy count value is not zero, when one of the predetermined specific operations is implemented, the solar energy count value is decreased, never below zero, and the count value of the said operation is increased.

If the energy count value is zero, when one of the predetermined specific operations is implemented, the energy count value and the count value of the said operation are not affected.

According to another aspect of the invention, the solar energy counting means 11 are such that the solar energy count value is converted into functioning time for some specific operations. For example, it can be converted in phone call time, time for listening to music, etc. For other operations, it can also be converted into a number of units processed by the said operations. For example, for operations of SMS transmission, it is converted to number of SMS messages sent.

Thus, if the solar energy count value is not zero, when one of the predetermined specific operations is implemented, the energy count value is reduced according to the amount of energy consumed and the count value of the said operation is increased either by the functioning time of the said operation or the number of units processed by the said operation, according to the operation in question.

In a particular embodiment, the counting means 11 are provided such that the energy count value can be reduced by an amount proportional to the functioning time of the operation or the number of units processed by the said operation.

Assuming that the battery 60 has been recharged by the solar panel 70 and the solar energy count value is 250. This value is converted into 25 minutes of phone voice communication, 250 SMS and 50 minutes of music listening.

Assuming that the user listens to music for 25 minutes. The solar energy count value will decrease as and when listening from 250 to 125. This value corresponds to 12mn30 of phone voice communication, 125 SMS and 25 minutes of music listening. As for the counter listening to music, it will be increased up to 25 minutes.

Assuming now that the user phones vocally for 35 minutes. The solar energy count value will fall to zero. On the other hand, the count value for the voice phone will be 25 minutes.

If the user now sends 25 SMS, the solar energy count value will always be zero. It is the same for the count value for the SMS.

The present invention also relates to a method implemented by a mobile phone such as just described and characterized in that it comprises a step of solar energy counting which includes a step of increasing the solar energy count value according to the electrical energy delivered by the said solar panel and a step of decreasing this solar energy count value according to the energy consumed by the said phone, the said decreasing step is provided such that the solar energy count value cannot fall below the value zero.

The said decreasing step is advantageously provided such that the said solar energy count value is reduced only when predetermined specific operations of the said phone are in use, such as operations for sending SMS, listening to music, voice communications.

As for the increasing step, it is advantageously provided such that, when the solar energy sensor charges the battery, the solar energy count value is increased according to the increase of the charge level of the battery.

The said method comprises, for each of the said predetermined specific operations, a counting step with the operation count value being increased when the said operation is implemented while the energy count value is not zero.

It includes conversion means for converting the solar energy count value into functioning time for some specific operations and/or into a number of units processed by some other specific operations.

The decreasing step is then advantageously provided such that the energy count value is either reduced by an amount proportional to the operating time of the operation of interest or the number of units processed by the said operation.

Alternatively, the decreasing step is provided such that, when the said the phone consumes energy due to the implementation of one of the said predetermined specific operations, the solar energy count value is reduced according to the decrease in the charge level of the battery, but never goes below zero.

1. A mobile phone powered by a battery (60) and comprising a solar panel (70) and a socket (62) for connecting an external source, the said socket and the said solar panel each being suitable for recharging the said battery (60), characterized in that it comprises solar energy counting means (11) which increase a solar energy count value according to the electrical energy delivered by the said solar panel (70) and decrease this solar energy count value according to the energy consumed by the said phone, the counting means (11) being provided such that the solar energy count value cannot fall below the zero value.

2. The mobile phone according to claim 1, characterized in that the said counting means (11) are provided such that the said solar energy count value is reduced only when some predetermined specific operations of the said phone are in use, such as operations of sending SMS, listening to music, voice communications.

3. The mobile phone according to claim 1, characterized in that the said counting means (11) are provided such that, when the solar energy panel (70) charges the battery (60), the solar energy count value is increased according to the increase of the charge level of the battery (60).

4. The mobile phone according to claim 2, characterized in that it comprises, for each of the said predetermined specific operations, a counter with the operation count value being increased when the said operation is implemented while the energy count value is not zero.

5. The mobile phone according to claim 2, characterized in that the counting means (11) are provided for converting the solar energy count value into functioning time for some specific operations and/or into a number of units processed by some other operations.

6. The mobile phone according to claim 5, characterized in that the said counting means (11) are provided such that the energy count value is reduced by an amount proportional to the functioning time of the operation or the number of units processed by the said operation.

7. The mobile phone according to claim 2, characterized in that the said counting means (11) are provided such that when the said phone consumes energy due to the implementation of one of the said predetermined specific operations, the solar energy count value is reduced according to the decrease in the charge level of the battery, without ever dropping below zero.

8. The mobile phone according to claim 2, characterized in that it comprises a light detector (80) and an alarm (81), the said alarm (81) being turned on, at least for one moment, repeated or not, when the amount of light received by the said light detector (80) is greater than a predetermined threshold.

9. The mobile phone according to claim 8, of the type comprising a screen (40) on one of its sides and the said solar panel (70) on the opposite side to that of the screen (40), characterized in that the said light detector (80) is on the side of the said screen (40).

10. The mobile phone according to claim 8, characterized in that the said alarm (81) is an indicator, such as a light emitting diode, or means for displaying a symbol (42) on the said screen (40) of the said phone, or sound emitting means (31, 32).

11. Method implemented by a mobile phone according to claim 1, characterized in that it comprises a step of counting solar energy (11) which comprises a step of increasing an energy count value depending on the electrical power delivered by the said solar panel (70) and a step of decreasing this solar energy count value according to the energy consumed by the said phone, the said decreasing step being provided for the solar energy count value not being able to decrease below the value zero.

12. The method implemented by a mobile phone according to claim 11, characterized in that the said decreasing step is provided such that the said the solar energy count value is reduced when only some predetermined specific operation of the said phone are in use, such as operations of sending SMS, listening to music, voice communications.

13. The method implemented by a mobile phone according to claim 11, characterized in that the increasing step is provided such that, when the solar panel (70) charges the battery (60), the solar energy count value is increased according to the increase of the charge level of the battery (60).

14. The method implemented by a mobile phone according to claim 12, characterized in that it comprises, for each of the said predetermined specific operations, a counting step with the operation count value being increased when the said operation is implemented when the energy count value is not zero.

15. The method implemented by a mobile phone according to claim 12, characterized in that it comprises conversion means for converting the solar energy count value into functioning time for some specific operations and/or into a number of units processed by some other operations.

16. The method implemented by a mobile phone according to claim 12, characterized in that the decreasing step is provided such that the energy count value is reduced by an amount proportional to the functioning time of the operation of interest or the number of units processed by the said operation.

17. The method implemented by a mobile phone according to claim 12, characterized in that the decreasing step is provided such that, when the said phone consumes energy due to the implementation of one of the said predetermined specific operations, the solar energy count value is reduced according to the decrease in the charge level of the battery, without ever dropping below zero.
